(19) United States
(12) Patent Application Publication
(10) Pub. No.: US 2021/0401017 A1
(43) Pub. Date: Dec. 30, 2021

(54) Preparation Method of Starch-based Double Emulsion Embedding Fat-soluble Functional Factors

(71) Applicant: Jiangnan University, Wuxi (CN)

(72) Inventors: Yan HONG, Wuxi (CN); Jie YANG, Wuxi (CN); Zhengbiao GU, Wuxi (CN); Li CHENG, Wuxi (CN); Zhaofeng LI, Wuxi (CN); Caiming LI, Wuxi (CN); Xiaofeng BAN, Wuxi (CN)

(21) Appl. No.: 17/467,323

(22) Filed: Sep. 6, 2021

Related U.S. Application Data
(63) Continuation of application No. PCT/CN2021/079744, filed on Mar. 9, 2021.

(30) Foreign Application Priority Data
Dec. 11, 2020 (CN) 2020114599729

(51) Int. Cl. A23L 29/10; A23L 29/219; A23L 2/52; A23L 29/00

(52) U.S. Cl. CPC A23L 29/10; A23L 29/04; A23L 2/52; A23L 29/219

(57) ABSTRACT

The disclosure discloses a preparation method of a starch-based double emulsion embedding fat-soluble functional factors, belonging to the technical field of preparation of emulsions. The preparation method of the disclosure includes the following steps: (1) adding a hydrophilic emulsifier into gelatinized starch milk, and uniformly mixing; adding an oil phase containing fat-soluble functional factors and a lipophilic emulsifier, and forming an O1/W starch-based single emulsion embedding fat-soluble functional factors by shearing, where a mass ratio of the hydrophilic emulsifier to the lipophilic emulsifier is 2-3:1-2; and (2) dropwise adding the O1/W starch-based single emulsion embedding fat-soluble functional factors into an oil phase and a lipophilic emulsifier, uniformly mixing, and then allowing the mixture to stand for retrogradation; and obtaining the O1/W/O2 starch-based double emulsion embedding fat-soluble functional factors. The method of the disclosure has the advantages of simple process and low cost, and is green and environmentally-friendly, and the prepared double emulsion has high storage stability, effectively reduces damage of external environment factors to the functional factors, and has a good slow release characteristic.

### TECHNICAL FIELD

The disclosure relates to a preparation method of a starch-based double emulsion embedding fat-soluble functional factors, belonging to the technical field of preparation of emulsions.

### BACKGROUND

At present, studies have found that fat-soluble functional factors have a certain nutritional value and have the effect of promoting human health, which mainly focus on anti-oxidation, anti-tumor, anti-cancer, anti-inflammation, prevention of cardiovascular diseases and the like. However, in practical application, the absorption and utilization of most functional factors are influenced by both the processing environment and the digestive tract physiological environment. Therefore, in order to control the retention, stability and release of active ingredients in the gastrointestinal tract, prevent or reduce the degradation of the active ingredients, improve the efficacy and reduce adverse side effects, it is key to find a delivery system that can enhance the processing stability of functional factors, improve their bioavailability and maintain their efficacy. In addition, most of the functional factors are released once in the body, which will seriously lead to poor control. Therefore, a slow-release carrier is needed to continuously provide the functional factors for the body and keep their concentration in a safe and effective range for a long time, thereby maintaining the provision of functional factors.

A double emulsion (O1/W/O2) is a multiphase composite emulsion combining characteristics of oil-in-water (O1/W) and water-in-oil (W/O2). The double emulsion has an internal oil phase O1, and fat-soluble functional factors can be added to the internal oil phase to achieve the embedding effect, thereby protecting the functional factors. In addition, the internal oil phase O1 of the double emulsion has a carrier, and an external oil phase O2 also has a carrier. These multiple carriers have slow release characteristics for functional factors, so the above two problems can be solved at the same time. Due to emulsifying properties, proteins are usually used to prepare double emulsion carrier materials. However, at present, most of existing protein double emulsion carriers are easily hydrolyzed by pepsin in gastric juice, which leads to the destruction of the double emulsion, and the functional factors are also released in the gastric juice and are difficult to reach the small intestine. Therefore, the oral protein double emulsion fails to achieve the effect of the functional factors.

Therefore, how to prepare a double emulsion that can continuously provide functional factors for the body and keep their concentration in a safe and effective range for a long time is an urgent technical problem to be solved at present.

### SUMMARY

In order to solve at least one of the problems above, the disclosure uses starch as a water phase to prepare a starch-based double emulsion, which has unique advantages in embedment of fat-soluble active substances and slow and controlled release in the gastrointestinal tract. The starch-based double emulsion prepared in the disclosure achieves the objective of sensitive release in an environment from simulated gastric juice to simulated intestinal juice, and increases a release amount of functional factors in the small intestine, thereby enhancing the oral utilization rate and bioavailability.

A first objective of the disclosure is to provide a method for preparing a starch-based double emulsion embedding fat-soluble functional factors, including the following steps:

(1) preparation of an O1/W starch-based single emulsion embedding fat-soluble functional factors

adding a hydrophilic emulsifier into gelatinized starch milk, and uniformly mixing; adding an oil phase containing fat-soluble functional factors and a lipophilic emulsifier, and forming an O1/W starch-based single emulsion embedding fat-soluble functional factors by shearing, where a mass ratio of the hydrophilic emulsifier to the lipophilic emulsifier is 2-3:3-2; and

(2) preparation of an O1/W/O2 starch-based double emulsion embedding fat-soluble functional factors

dropwise adding the O1/W starch-based single emulsion embedding fat-soluble functional factors prepared in step (1) into an oil phase and a lipophilic emulsifier, uniformly mixing, and then allowing the mixture to stand for retrogradation; and obtaining the O1/W/O2 starch-based double emulsion embedding fat-soluble functional factors.

In an embodiment of the disclosure, a preparation method of the gelatinized starch milk in step (1) includes: adding water into starch, uniformly mixing to obtain a starch milk, gelatinizing the starch milk in a boiling water bath for 20-40 min until the starch milk is completely gelatinized, and finally, keeping the temperature at 80° C. for later use, where a concentration of the starch milk is 1-7 wt %.

In an embodiment of the disclosure, a concentration of the gelatinized starch milk in step (1) is 1-7 wt %.

In an embodiment of the disclosure, the starch in step (1) includes one or more of corn starch, potato starch, cassava starch, waxy corn starch, pea starch, wheat starch, rice starch and high amylose starch.

In an embodiment of the disclosure, when the starch used in the preparation of the gelatinized starch milk in step (1) is high amylose starch, the gelatinization requires placing high amylose starch milk in a pressure bottle, gelatinizing the starch milk in a boiling water bath for 20-40 min and then treating the gelatinized starch milk in a 130° C. oven for 2-4 h.

In an embodiment of the disclosure, the fat-soluble functional factors in step (1) include one or more of astaxanthin, vitamin E, lycopene, β-carotene, conjugated linoleic acid and curcumin.

In an embodiment of the disclosure, the oil phase containing fat-soluble functional factors in step (1) and the oil phase in step (2) are both soybean oil.

In an embodiment of the disclosure, a mass ratio of the hydrophilic emulsifier to the lipophilic emulsifier in step (1) is 3:2.

In an embodiment of the disclosure, the hydrophilic emulsifier in step (1) is Tween 20.

In an embodiment of the disclosure, the lipophilic emulsifier in step (1) and step (2) is Span 80.

In an embodiment of the disclosure, the hydrophilic emulsifier and the lipophilic emulsifier in step (1) account for 2-3% by volume of the O1/W starch-based single emulsion embedding fat-soluble functional factors.

In an embodiment of the disclosure, a volume ratio of the oil phase containing fat-soluble functional factors to the gelatinized starch milk in step (1) is 3-4:6-7.

In an embodiment of the disclosure, in step (1), a shear rate is 10000-18000 rpm, and a shear time is 1-3 min.

In an embodiment of the disclosure, a preparation method of the oil phase containing fat-soluble functional factors in step (1) includes: dissolving fat-soluble functional factors in an oil phase to obtain the oil phase containing fat-soluble functional factors, where a concentration of the fat-soluble functional factors is 0.05-0.5 mg/mL.

In an embodiment of the disclosure, a rate of dropwise adding in step (2) is 1-2 mL/min.

In an embodiment of the disclosure, a volume ratio of the O1/W starch-based single emulsion embedding fat-soluble functional factors to the oil phase in step (2) is 2-3:2-3, preferably 3:2.

In an embodiment of the disclosure, the lipophilic emulsifier in step (2) accounts for 1-3% by volume of the O1/W/O2 starch-based double emulsion embedding fat-soluble functional factors.

In an embodiment of the disclosure, a time of the uniform stirring in step (2) is 1-3 min, and a temperature is 25° C.

In an embodiment of the disclosure, the standing for retrogradation in step (2) is retrogradation at 3-5° C. for 12-24 h, preferably retrogradation at 4° C. for 12-24 h.

In an embodiment of the disclosure, the uniform mixing in step (2) is uniform stirring and mixing at 1000-2000 r/min.

A second objective of the disclosure is a starch-based double emulsion embedding fat-soluble functional factors prepared by the method of the disclosure.

A third objective of the disclosure is application of the starch-based double emulsion embedding fat-soluble functional factors of the disclosure in the field of food.

In an embodiment of the disclosure, the application is to add the starch-based double emulsion embedding fat-soluble functional factors prepared in the disclosure into beverages as a nutritional oral liquid or a nutritional enhancer.

The disclosure has the following beneficial effects:

(1) In the disclosure, high-speed shearing and high-speed dropwise adding are used to prepare the starch-based double emulsion embedding fat-soluble functional factors. The method of the disclosure is green and environmentally-friendly, and has the advantages of simple operation, high efficiency and stability, low cost and higher embedding rate of fat-soluble functional factors.

(2) The release behavior of the starch-based double emulsion carrier embedding fat-soluble functional factors prepared in the disclosure is determined by the structural stability.

Under acidic conditions of the stomach, due to the binding of hydrogen ions, the repulsion between the emulsion droplets is enhanced and the stability is enhanced. Besides, the gelatinized starch network is relatively dense, so its structure is not destructed, and the functional factors are almost not released. In the weakly acidic to weakly alkaline small intestine, the emulsion will accelerate the collision between droplets along with the peristalsis of the intestinal tract, resulting in the unstable effect of coagulation and Ostwald ripening or the expansion, so that the fat-soluble functional factors can achieve the effect of slow release in the small intestine.

(3) The starch-based double emulsion of the disclosure can effectively reduce damage of external environment factors (such as light, oxygen and temperature) to the functional factors, enhance the water solubility of the fat-soluble functional factors, reduce the destruction of the functional factors in the stomach and enhance the release rate of the functional factors at the upper end of the small intestine, thereby enhancing the bioavailability.

(4) The starch-based double emulsion obtained in the disclosure has a mean droplet size of only 2.22±0.33 μm and a creaming index Cl of 0%; an embedding rate of astaxanthin is up to 97.20±0.01%; a release amount in the stomach is only 9.67±0.18%, and a release amount after 720 min of release in intestinal juice reaches 32.11±1.25%, so a controlled and slow release effect can be achieved; and the starch-based double emulsion has high oxidation resistance and DPPH radical scavenging activity, reaching 77.51±2.33% or more.

### BRIEF DESCRIPTION OF FIGURES

FIG. 1A shows microscopic images of double emulsions prepared by Examples 1.

FIG. 1B shows microscopic images of double emulsions prepared by Examples 7.

FIG. 1C shows microscopic images of double emulsions prepared by Examples 8.

FIG. 2A shows apparent shear stress diagram of the double emulsions prepared by Examples 1, 7 and 8.

FIG. 2B shows diagram of storage modulus G′ and loss modulus G″ of the double emulsions prepared by Examples 1, 7 and 8.

FIG. 3 is a diagram showing mean droplet size of the double emulsions prepared by Examples 1, 7 and 8.

FIG. 4A shows apparent storage stability of the double emulsions prepared by Examples 1, 7 and 8 after storage for 35 days.

FIG. 4A shows the creaming index of the double emulsions prepared by Examples 1, 7 and 8 after storage for 35 days.

FIG. 5 is a curve graph showing release of the double emulsions prepared by Examples 1, 7 and 8.

FIG. 6 is a diagram showing DPPH radical scavenging activity of the double emulsions prepared by Examples 1, 7 and 8.

FIG. 7A shows microscopic images of double emulsions prepared by Control Examples 1.

FIG. 7B shows microscopic images of double emulsions prepared by Control Examples 2.

FIG. 7C shows microscopic images of double emulsions prepared by Control Example 3.

FIG. 8A is backscattering intensity of the double emulsions prepared by Control Example 2.

FIG. 8B is Turbiscan stability index of the double emulsions prepared by Control Example 2.

### DETAILED DESCRIPTION

Preferred Examples of the disclosure will be described below. It should be understood that the Examples are intended to better explain the disclosure and are not intended to limit the disclosure.

Test Methods:

1. Micromorphology

A BX41 Olympus optical microscope was used to observe the microstructure of a sample.

Before observing the sample, the sample needed to be diluted 100 times. An appropriate amount of diluted sample was placed on a glass slide, and a cover glass was placed for observation.

2. Determination of Apparent Rheological Properties

A 40 mm stainless steel plate was selected, and a TA Instrument rheometer was used to determine shear stress of the sample at a shear rate of 0.01-500 1/s. Within an angular frequency scanning range of 0.1-100 rad/s, viscoelasticity of different samples is determined at a strain of 1% (linear viscoelastic region).

3. Determination of Multiple Light Scattering Stability

A Turbiscan Lab multiple light scattering stability instrument was used for determination. The sample was put into a special sample bottle while making sure that there were no bubbles, and the special sample bottle was put into sample cell of the instrument. Scanning was performed every 110 s for 4 h. After multiple scans and software calculation, a stability parameter change curve was obtained.

4. Determination of Droplet Size

The sample cells was filled with distilled water. After the system finished measuring the light and background, an S3500 laser particle size analyzer was used to determine a volume mean droplet size d₅₀ of the sample, and a mean of the three tests was taken. A droplet refractive index parameter was 1.59.

5. Determination of Apparent Storage Stability

A starch-based double emulsion containing fat-soluble functional factors was placed at 4° C. to stand for 35 days. The creaming was observed, and a creaming index (Cl value) was calculated. The specific calculation formula is Formula (1) as follows:

$$CI ( \% ) = \frac{Hs}{Ht} \times 100 \qquad ( 1 )$$

In Formula (1), Ht represents the total height of the emulsion (cm), and Hs represents the height of the creamed clear sample (cm).

6. Determination of Embedding Rate

5 mL of acetone was added to 0.5 mL of starch-based double emulsion embedding fat-soluble functional factors, uniform mixing was performed by vortex for 2 min, the mixture was centrifuged at 5000 r/min for 10 min, and an ultraviolet absorption value of the supernatant was determined. The calculation formula of the embedding rate is Formula (2) as follows:

$$Embedding rate ( \% ) = \frac{fat \text{-} soluble functional factors embedded}{\begin{matrix}mass of total soluble functional \\ factors in double emulsion\end{matrix}} \times 100 \qquad ( 2 )$$

7. Determination of Release in Simulated Gastric Juice and Intestinal Juice

The simulated gastric juice was composed of pepsin (0.32%, w/v), sodium chloride (0.2%, w/v) and hydrochloric acid (0.7%, v/v), and the pH value was adjusted to 2 with hydrochloric acid. The simulated intestinal juice was composed of sodium chloride (150 mM), calcium chloride ((30 mM)), pancreatin (100 U/mg) and bile salt (5 mg/mL), and the pH value was adjusted to 7 with sodium hydroxide.

5 mL of the starch-based double emulsion embedding fat-soluble functional factors was placed in a dialysis bag (the molecular weight was 30 KDa). Then, the dialysis bag was placed in 100 mL of the simulated gastric juice, and cultured at 37° C. for 2 h, and the mixture was slowly stirred. Then, the dialysis bag was transferred into 100 mL of the simulated intestinal juice, and cultured at 37° C. for 10 h. 2 mL of release solution was taken out at regular intervals and mixed with 1 mL of acetone, the absorption value was determined with an ultraviolet spectrophotometer, the mass of the fat-soluble functional factors released was calculated, and the release curve was drawn. The calculation formula of the release rate is Formula (3) as follows:

$$Release rate of fat \text{-} soluble functional factors ( \% ) = \frac{mass of fat \text{-} soluble functional factors released}{mass of total fat \text{-} soluble functional factors} \times 100 \qquad ( 3 )$$

8. Determination of Oxidation Resistance

1,1-diphenylpicryl phenylhydrazyl (DPPH) radicals were dissolved in ethanol to prepare a 0.15 M DPPH solution. 10 mL of the DPPH solution was mixed with the same amount of double emulsion, and the mixture was treated at 25° C. in a dark place for 30 min. An ultraviolet absorption value at 517 nm was determined, and a DPPH radical scavenging activity (KD) was calculated. The specific calculation formula is Formula (4) as follows:

$$KD ( \% ) = 100 - \frac{ABs 0 - ABs 1}{ABs 0} \times 100 \qquad ( 4 )$$

In Formula (4), ABs0 is the absorption value of the control sample; and ABs1 is the absorption value of the sample.

### Example 1

A preparation method of a starch-based double emulsion embedding astaxanthin, included the following steps:

(1) Preparation of Astaxanthin-Containing Soybean Oil:

1.5 mg of astaxanthin was dissolved in 15 mL of soybean oil and stirred until being completely dissolved to prepare astaxanthin-containing soybean oil with a mass concentration of 0.1 mg/mL.

(2) Preparation of Gelatinized Starch Milk:

2.5 g of corn starch was dispersed in 50 mL of water, and uniformly stirred to prepare 5 wt % starch milk, the starch milk was gelatinized in a boiling water bath for 30 min until being completely gelatinized, and kept at 80° C.; and gelatinized starch milk was obtained.

(3) Preparation of O1/W Starch-Based Single Emulsion Embedding Fat-Soluble Functional Factors:

0.6 mL of hydrophilic emulsifier Tween 20 was added to 35 mL of the gelatinized starch milk in step (2), and uniformly stirred. 15 mL of the astaxanthin-containing soybean oil prepared in step (1) and 0.4 mL of lipophilic emulsifier Span 80 were added, and the entire system was sheared by a high-speed disperser at a high speed of 16000 rpm for 2 min to obtain a starch-based O1/W single emulsion embedding astaxanthin.

(4) Preparation of O1/W/O2 Starch-Based Double Emulsion Embedding Astaxanthin:

30 mL of the starch-based O1/W single emulsion embedding astaxanthin obtained in step (3) was dropwise added (the dropwise adding rate was 1 mL/min) to 20 mL of soybean oil and 1 mL of Span 80, and the mixture was stirred uniformly at 25° C. at a high rate of 1500 r/min for 2 min and was allowed to stand at 4° C. for retrogradation for 12 h to obtain the O1/W/O2 starch-based double emulsion embedding astaxanthin.

The obtained O1/W/O2 starch-based double emulsion was subjected to a performance test. The test results are as follows: the double emulsion has a mean droplet size of 2.22±0.33 μm and a creaming index Cl of 0%; an embedding rate of astaxanthin is up to 97.20±0.01%; a release amount in the stomach is only 9.67±0.18%, and a release amount after 720 min of release in intestinal juice is 32.11±1.25%, so a controlled and slow release effect can be achieved; and the starch-based double emulsion has high oxidation resistance and DPPH radical scavenging activity, reaching 77.51±2.33%.

### Example 2

The volume ratio of the hydrophilic emulsifier Tween 20 and the lipophilic emulsifier Span 80 in step (3) in Example 1 was adjusted, as shown in Table 1. The total volume was 1 mL, and the others were the same as in Example 1 to obtain an O1/W starch-based single emulsion embedding fat-soluble functional factors.

The obtained O1/W starch-based single emulsion embedding fat-soluble functional factors was subjected to a performance test. The test results are shown in Table 1:

TABLE 1
Test results of Example 2

| | Droplet Size of Single | |
|---|---|---|
| Tween 20:Span 80 | Emulsion (nm) | Droplet Size Distribution |
| 1:0 | 500-1000 | Nonuniform |
| 0.8:0.2 | 200-500 | Nonuniform |
| 0.6:0.4 (Example 1) | 200 | Uniform |
| 0.5:0.5 | 100-500 | Nonuniform |

### Example 3

The high-speed shear rate in step (3) in Example 1 was adjusted, as shown in Table 2, and the others were the same as in Example 1 to obtain an O1/W starch-based single emulsion embedding fat-soluble functional factors.

The obtained O1/W starch-based single emulsion embedding fat-soluble functional factors was subjected to a performance test. The test results are shown in Table 2:

TABLE 2
Test results of Example 3

| High-speed Shear Rate | Droplet Size of Single |
|---|---|
| (rpm) | Emulsion (nm) |
| 10000 | 500 |
| 14000 | 300 |
| 16000 (Example 1) | 200 |
| 18000 | 200 |

### Example 4

The volume ratio of the starch-based O1/W single emulsion embedding astaxanthin to the soybean oil in step (4) in Example 1 was adjusted, as shown in Table 3, and the others were the same as in Example 1 to obtain an O1/W/O2 starch-based double emulsion embedding astaxanthin.

The obtained O1/W/O2 starch-based double emulsion embedding astaxanthin was subjected to a performance test. The test results are shown in Table 3:

TABLE 3
Test results of Example 4

| Volume Ratio of Single | Can double emulsion | Droplet Size of Double |
|---|---|---|
| Emulsion to Soybean Oil | be formed? | Emulsion (μm) |
| 1:4 | No | / |
| 2:3 | Yes | 5-6 |
| 3:2 (Example 1) | Yes | 1 |
| 4:1 | No | / |

### Example 5

The retrogradation time in step (4) in Example 1 was adjusted, as shown in Table 4, and the others were the same as in Example 1 to obtain an O1/W/O2 starch-based double emulsion embedding astaxanthin.

The obtained O1/W/O2 starch-based double emulsion embedding astaxanthin was subjected to a performance test. The test results are shown in Table 4:

TABLE 4
Test results of Example 5

| Time h | Apparent Stability |
|---|---|
| 0 | Creamed |
| 4 | Creamed |
| 8 | Creamed |
| 12 (Example 1) | Stable |
| 24 | Stable |

### Example 6

The retrogradation temperature in step (4) in Example 1 was adjusted, as shown in Table 5, and the others were the same as in Example 1 to obtain an O1/W/O2 starch-based double emulsion embedding astaxanthin.

The obtained O1/W/O2 starch-based double emulsion embedding astaxanthin was subjected to a performance test. The test results are shown in Table 5:

TABLE 5
Test results of Example 6

| Temperature ° C. | Apparent Stability |
|---|---|
| 4 (Example 1) | Stable |
| 25 | Creamed |

### Example 7

A preparation method of a starch-based double emulsion embedding β-carotene included the following steps:

The astaxanthin in Example 1 was replaced with β-carotene, the concentration of the starch milk in step (2) was adjusted to 7 wt %, and the others were the same as in Example 1 to obtain an O1/W/O2 starch-based double emulsion embedding β-carotene.

### Example 8

A preparation method of a starch-based double emulsion embedding lycopene, included the following steps:

The astaxanthin in Example 1 was replaced with lycopene, and the corn starch in step (2) was replaced with high amylose corn starch (the amylose content was 60%). The gelatinization steps included: 2.5 g of the high amylose starch was dispersed in 50 mL of water to prepare 5 wt % starch milk, the starch milk was placed in a pressure bottle and gelatinized in a boiling water bath for 30 min, and finally, the gelatinized starch milk was treated in a 130° C. oven for 2 h to obtain gelatinized high amylose starch milk. The others were the same as in Example 1 to obtain an O1/W/O2 starch-based double emulsion embedding lycopene.

The test results of the embedding rate of the double emulsions prepared by Examples 1, 7 and 8 are shown in Table 6:

TABLE 6
Test results of embedding rate of double emulsions prepared
by Examples 1, 7 and 8

| Double Emulsion | | | |
|---|---|---|---|
| Sample | Example 1 | Example 8 | Example 9 |
| Embedding Rate | 97.20 ± 0.01 | 97.95 ± 0.18 | 96.22 ± 0.12 |
| (%) | | | |

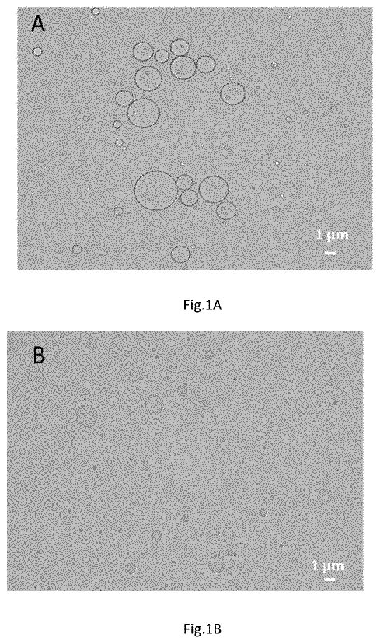

Microscopic images of the double emulsions prepared by Examples 1, 7 and 8 are shown in FIG. 1A, FIG. 1B and FIG. 1C. It can be seen from FIG. 1A, FIG. 1B and FIG. 1C that: when the concentration of common corn starch in Example 1 is 5 wt %, the formed double emulsion embedding fat-soluble functional factors have a droplet size of about 2-3 microns; when the concentration of common corn starch in Example 7 is 7 wt %, the formed double emulsion embedding fat-soluble functional factors have a droplet size of 1-2 microns; and when the concentration of high amylose corn starch in Example 8 is 5 wt %, the formed double emulsion embedding fat-soluble functional factors have a droplet size of about 1 micron.

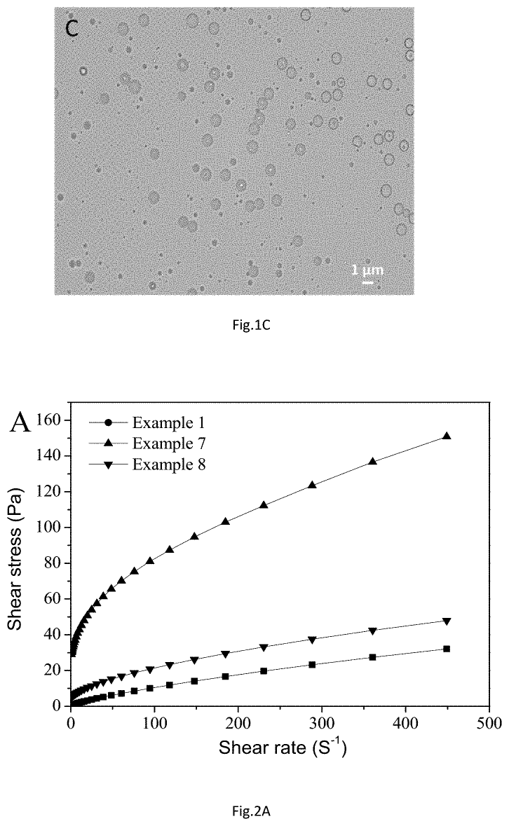

Apparent rheology diagrams of the double emulsions prepared by Examples 1, 7 and 8 are shown in FIG. 2A and FIG. 2B. It can be seen from FIG. 2A and FIG. 2B that: when the concentration of the common corn starch is 7 wt %, the entire double emulsion system has the largest viscosity; and in addition, the storage modulus and loss modulus of the double emulsion embedding fat-soluble functional factors prepared from the 7 wt % common corn starch do not change with the change of the shear rate, and the storage modulus is larger than the loss modulus, indicating solid-like behaviors.

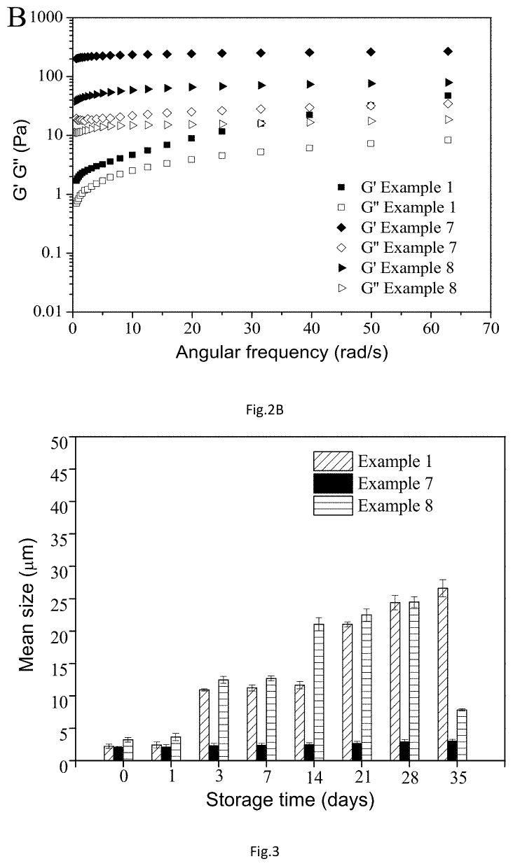

A diagram showing mean droplet size of the double emulsions prepared by Examples 1, 7 and 8 is shown in FIG. 3. It can be seen from FIG. 3 that: after the double emulsion embedding fat-soluble functional factors prepared from the 7 wt % common corn starch is stored for 35 days, the mean droplet size remains at about 2 microns, with almost no change, indicating that the double emulsion has high storability. However, after 14 days, the mean droplet size of the double emulsion embedding fat-soluble functional factors prepared from 5 wt % common corn starch and high amylose starch increase obviously, indicating that the emulsion has an aggregated or merged phenomenon.

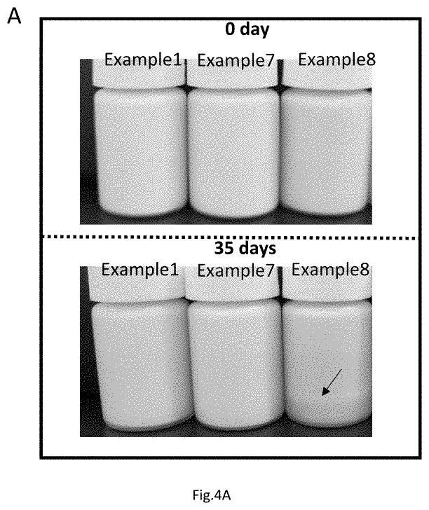

Apparent storage stability and creaming index of the double emulsions prepared by Examples 1, 7 and 8 after the storage for 35 days are shown in FIG. 4A and FIG. 4B. A is the apparent storage stability, and B is the creaming index. It can be seen from FIG. 4A and FIG. 4B that: after 35 days of storage, only the starch double emulsion embedding fat-soluble functional factors prepared by Example 8 has creamed, and the others have not creamed. The creaming index also can show more visually that the double emulsion prepared from common corn starch is more stable than the double emulsion prepared from high amylose starch.

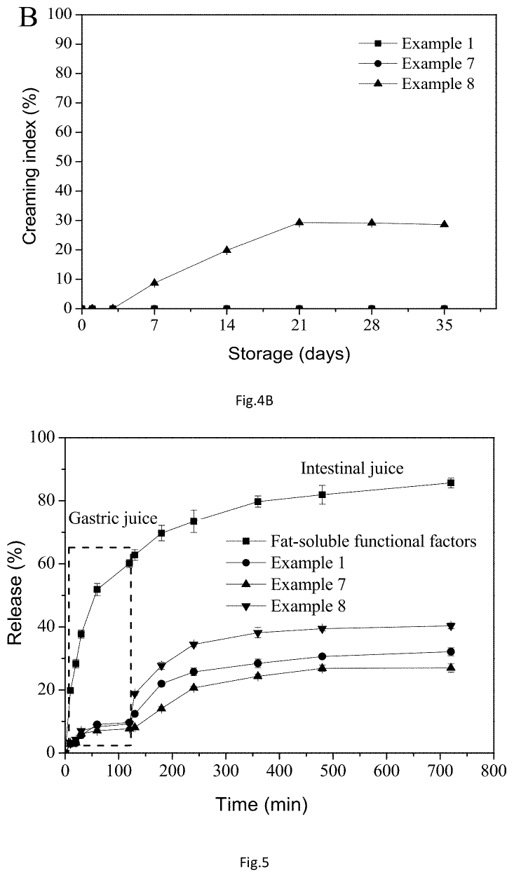

A curve graph showing release of the double emulsions prepared by Examples 1, 7 and 8 is shown in FIG. 5. It can be seen from FIG. 5 that: the fat-soluble functional factors embedded in the starch-based double emulsion carrier have only a small release amount of about 15% in simulated gastric juice, but have a release amount of 40% in simulated intestinal juice. The fat-soluble functional factors are released slowly. Therefore, the starch-based double emulsion can control the fat-soluble functional factors such as astaxanthin not released in the gastric juice but released in the intestinal juice, and the carrier has the characteristic of slow release.

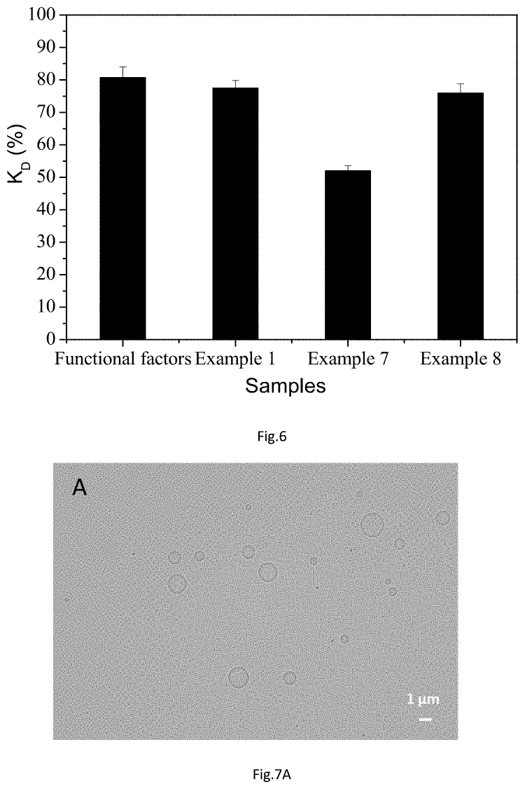

A diagram showing DPPH radical scavenging activity of the double emulsions prepared by Examples 1, 7 and 8 is shown in FIG. 6. It can be seen from FIG. 6 that: compared with the non-embedded fat-soluble functional factors, the embedded starch fat-soluble functional factors have higher DPPH radical scavenging activity.

### Control Example 1 No Functional Factors Embedded

A preparation method of a starch-based double emulsion included the following steps:

(1) Preparation of Gelatinized Starch Milk:

2.5 g of common corn starch was dispersed in 50 mL of water, and uniformly stirred to prepare 5 wt % starch milk, the starch milk was gelatinized in a boiling water bath for 30 min until being completely gelatinized, and kept at 80° C.; and gelatinized starch milk was obtained.

(2) Preparation of O1/W starch-based single emulsion: 0.3 mL of hydrophilic emulsifier Tween 20 was added to 35 mL of the gelatinized starch prepared in step (1), and uniformly stirred, the mixture was added to 15 mL of soybean oil, and 0.2 mL of lipophilic emulsifier Span 80 was added. The total volume of the emulsifiers accounted for 1% of the entire system. The entire system was sheared by a high-speed disperser at a high speed of 16000 rpm for 2 min to obtain an embedded starch-based O1/W single emulsion.

(3) Preparation of O1/W/O2 starch-based double emulsion: 30 mL of the O1/W emulsion prepared in step (2) was dropwise added (the dropwise adding rate was 1 mL/min) to 20 mL of soybean oil and 0.5 mL of Span 80, and uniformly stirred at 25° C. at a high rate of 1500 r/min for 2 min, and the mixture was allowed to stand at 4° C. for retrogradation for 12 h to obtain an O1/W/O2 starch-based double emulsion.

### Control Example 2

The amount of the hydrophilic emulsifier Tween 20 in step (2) in Control Example 1 was adjusted to 0.6 mL, the amount of the lipophilic emulsifier Span 80 was adjusted to 0.4 mL, and the total volume of the emulsifiers accounted for 2% of the entire system. The others were the same as in Control Example 1 to obtain an O1/W/O2 starch-based double emulsion.

### Control Example 3

The amount of the hydrophilic emulsifier Tween 20 in step (2) in Control Example 1 was adjusted to 0.9 mL, the amount of the lipophilic emulsifier Span 80 was adjusted to 0.6 mL, and the total volume of the emulsifiers accounted for 3% of the entire system. The others were the same as in Control Example 1 to obtain an O1/W/O2 starch-based double emulsion.

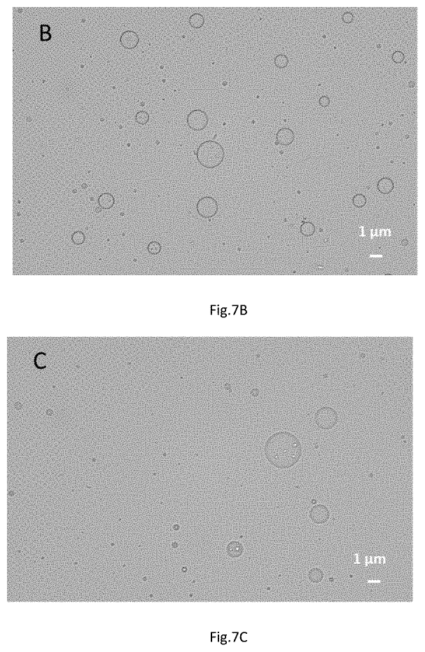

Microscopic images of double emulsions prepared by Control Examples 1, 2 and 3 are shown in FIG. 7A, FIG. 7B and FIG. 7C. It can be seen from FIG. 7A, FIG. 7B and FIG. 7C that: when the concentration of the emulsifiers is 2%, a larger amount of starch-based double emulsion is formed, and the starch-based double emulsion has uniform distribution and has a droplet size of 1-3 microns.

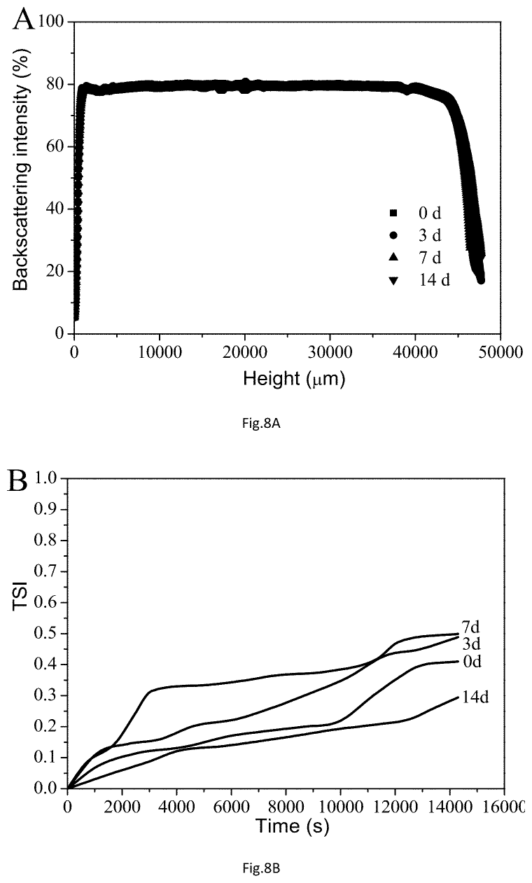

Diagrams showing overall storage stability of the double emulsion prepared by Control Example 2 are shown in FIG. 8A and FIG. 8B. It can be seen from FIG. 8A and FIG. 8B that: with the extension of storage time, the backscattering light intensity of the double emulsion prepared from 5 wt % common corn starch in the horizontal section has almost no change, and when the backscattering light intensity drops sharply, the height of the corresponding scanned sample is also unchanged, indicating that the double emulsion prepared by Control Example 2 has higher stability. In terms of Turbiscan stability index (TSI), it can also be seen that within 14 days, the TSI value of the double emulsion is about 0.5 all the time, indicating that the double emulsion has the best stability.

Test results of the double emulsions prepared by Control Examples 1, 2 and 3 are shown in Table 7:

TABLE 7
Test results of Control Examples 1-3

| | Volume Ratio of | Can double emulsion | Droplet Size |
|---|---|---|---|
| Example | Emulsifier to System (%) | be formed? | (μm) |
| Control | 1 | No | / |
| Example 1 | | | |
| Control | 2 | Yes | 1-2 |
| Example 2 | | | |
| Control | 3 | Yes | 1-3 |
| Example 3 | | | |

What is claimed is:

1. A method for preparing a starch-based double emulsion embedding fat-soluble functional factors, comprising the following steps:
(1) preparation of an O1/W starch-based single emulsion embedding fat-soluble functional factors:
adding a hydrophilic emulsifier into gelatinized starch milk and uniformly mixing; and adding an oil phase containing fat-soluble functional factors and a lipophilic emulsifier, and forming the O1/W starch-based single emulsion embedding fat-soluble functional factors by shearing, wherein a mass ratio of the hydrophilic emulsifier to the lipophilic emulsifier is 2-3:2-3; and
(2) preparation of an O1/W/O2 starch-based double emulsion embedding fat-soluble functional factors:
dropwise adding the O1/W starch-based single emulsion embedding fat-soluble functional factors prepared in step (1) into an oil phase and a lipophilic emulsifier, uniformly mixing, and then allowing the mixture to stand for retrogradation; and obtaining the O1/W/O2 starch-based double emulsion embedding fat-soluble functional factors.

2. The method according to claim 1, wherein the fat-soluble functional factors in step (1) comprise one or more of astaxanthin, vitamin E, lycopene, β-carotene, conjugated linoleic acid and curcumin.

3. The method according to claim 1, wherein a volume ratio of the O1/W starch-based single emulsion embedding fat-soluble functional factors to the oil phase in step (2) is 2-3:2-3.

4. The method according to claim 1, wherein the retrogradation in step (2) is retrogradation at 3-5° C. for 12-24 h.

5. The method according to claim 1, wherein in step (1), a shear rate is 10000-18000 rpm, and shear time is 1-3 min.

6. The method according to claim 1, wherein the hydrophilic emulsifier and the lipophilic emulsifier in step (1) account for 2-3% by volume of the O1/W starch-based single emulsion embedding fat-soluble functional factors.

7. The method according to claim 1, wherein a volume ratio of the oil phase containing fat-soluble functional factors to the gelatinized starch milk in step (1) is 3-4:6-7.

8. The method according to claim 1, wherein a concentration of the gelatinized starch milk in step (1) is 1-7 wt %.

9. The method according to claim 1, wherein a preparation method of the oil phase containing fat-soluble functional factors in step (1) comprises: dissolving fat-soluble functional factors in an oil phase to obtain the oil phase containing fat-soluble functional factors, wherein a concentration of the fat-soluble functional factors is 0.05-0.5 mg/mL.

10. The method according to claim 1, wherein the starch in step (1) comprises one or more of corn starch, potato starch, cassava starch, waxy corn starch, pea starch, wheat starch, rice starch and high amylose starch.

11. The method according to claim 1, wherein the lipophilic emulsifier in step (2) accounts for 1-3% by volume of the O1/W/O2 starch-based double emulsion embedding fat-soluble functional factors.

12. The method according to claim 1, wherein the hydrophilic emulsifier in step (1) is Tween 20.

13. The method according to claim 1, wherein the lipophilic emulsifier in step (1) and step (2) is Span 80.

14. The method according to claim 1, wherein a mass ratio of the hydrophilic emulsifier to the lipophilic emulsifier in step (1) is 3:2.

15. The method according to claim 1, wherein a speed of dropwise adding in step (2) is 1-2 mL/min.

16. A starch-based double emulsion embedding fat-soluble functional factors prepared by the method according to claim 1.

17. A method of using the starch-based double emulsion embedding fat-soluble functional factors according to claim 16, comprising: adding the starch-based double emulsion embedding fat-soluble functional factors into food as a nutritional oral liquid or a nutritional enhancer.

18. The method according to claim 17, wherein the food is a beverage.
